(19) United States
(12) Patent Application Publication
(10) Pub. No.: US 2009/0242785 A1
(43) Pub. Date: Oct. 1, 2009

(54) SUPER CONDUCTING BEAM GUIDANCE MAGNET, WHICH CAN ROTATE AND HAS A SOLID-STATE CRYOGENIC THERMAL BUS

(76) Inventor: Günter Ries, Erlangen (DE)

Correspondence Address: STAAS & HALSEY LLP, SUITE 700, 1201 NEW YORK AVENUE, N.W., WASHINGTON, DC, 20005, US

(21) Appl. No.: 12/309,743

(22) PCT Filed: Jul. 5, 2007
(86) PCT No.: PCT/EP2007/056830

§ 371 Date: Jan. 28, 2009

(30) Foreign Application Priority Data
Jul. 28, 2006 (DE) 102006035101.0

(51) Int. Cl. G21K 1/08; H01F 6/04

(52) U.S. Cl. 250/396 R; 335/216

(57) ABSTRACT

The beam guidance magnet for deflection of a beam of electrically charged particles can rotate about an axis located outside the magnet, and free of ferromagnetic material influencing the beam guidance. The beam guidance magnet contains a system of at least four curved superconducting individual coils which extend in the guidance direction of the particle beam and are arranged in pairs, in the mirror-image form with respect to a beam guidance plane which is predetermined by the curved particle path. The beam guidance magnet also contains a cooling apparatus having at least one heat sink and at least one solid-state cryogenic thermal bus, with super convecting individual coils being thermally coupled to the at least one heat sink via the solid-state cryogenic thermal bus.

### CROSS REFERENCE TO RELATED APPLICATIONS

This application is based on and hereby claims priority to German Application No. 10 2006 035 101.0 filed on Jul. 28, 2006 and PCT Application No. PCT/EP2007/056830 filed on Jul. 5, 2007, the contents of which are hereby incorporated by reference.

### BACKGROUND OF THE INVENTION

The invention relates to a beam guidance magnet for deflecting a beam of electrically charged particles along a curved particle path.

Such a curved beam guidance magnet is proposed in the DE application 10 2006 018 635.4, which was not yet published at the priority date of the present application.

High-power magnets are widely employed as beam guidance, deflection and focusing magnets in particle accelerator systems. Particle accelerator systems may be designed in particular for beam therapy in the field of medical technology. A beam therapy system of this type is disclosed, for example, by U.S. Pat. No. 4,870,287. Such a beam therapy system typically comprises a particle source and an accelerator for generating a high-energy particle beam. The particle beam emerging in a particular direction from the accelerator, due to the geometry of the accelerator system, is directed for therapeutic purposes onto a subject's region to be irradiated, for example a tumor. The particle beam emerging from the accelerator system is directed with the aid of a plurality of deflection, focusing and guidance magnets from its original direction, defined by the geometry of the accelerator system, typically at an angle of 90°, onto the subject. In order to keep the radiation dose as small as possible in the subject's surrounding tissue, which is not to be treated, the beam direction before the particle beam reaches the tissue to be treated is continuously varied as a function of time.

To this end, accelerator systems suitable for beam therapy have a so-called “gantry” which includes a multiplicity of beam deflection, guidance and focusing magnets and can typically be rotated about the axis which is defined by the geometry of the accelerator system, the direction of the beam of charged particles. A gantry in this context is intended to mean an arrangement of a plurality of beam deflection, guidance and focusing magnets that are arranged on a frame, which is mounted so that it can rotate about a particular predetermined axis. The beam emerging from the accelerator system is deflected by the gantry described above so that, when leaving the gantry at different rotation angles thereof, it always passes through a fixed point at the so-called “isocenter”. By such a variation of the beam direction, the beam dose outside the so-called isocenter, i.e. the beam dose of the region which is not to be irradiated, is distributed over a volume which is as large as possible. In this way the region lying outside the isocenter, which is not to be irradiated for therapeutic purposes, can be protected.

A gantry as described above contains, inter alia, curved beam guidance and/or deflection magnets. Such deflection magnets, which are suitable for use in a gantry, are known for example from WO 02/063638 A1 or WO 02/069350 A1. The curved guidance and/or deflection magnets which may be found in said documents are formed by conductors made of normally conducting material, for example copper (Cu). In order to form the magnetic field which deflects the beam of charged particles, the curved beam guidance and/or deflection magnets are typically also equipped with devices for magnetic field guidance or shaping. To this end the magnetic field-guiding parts, or yokes, are made of ferromagnetic material, for example iron. Owing to magnetic saturation of the iron, the magnetic field available for the beam deflection is limited to a value of at most about 1.8 tesla. This physical limit leads to a predetermined minimum deflection radius for the charged particles, which furthermore depends on their type. Typically, these deflection radii are a few meters in the case of C⁶⁺ ions used for beam therapy. Owing to the use of iron yokes and other ferromagnetic magnetic field-shaping devices, the weight of a gantry is typically about 100 t.

The frame of the rotatably mounted gantry must be configured very stably owing to this heavy weight, and at the same time must allow exact reproducible positioning of the magnets in order to ensure exact beam guidance. The normally conducting magnet windings must furthermore be cooled, for example with water. The electrical power consumption of a gantry with normally conducting windings may typically be about 800 kW; the gantry also has a considerable requirement for cooling water.

A gantry, in which the magnet windings are made with superconductors, is proposed in the DE application 10 2006 018 635.4, which was not yet published at the priority date of the present application. In order to keep the superconducting magnet windings in their superconducting state, it is necessary to maintain them at a sufficiently low temperature for the superconductivity at each rotation angle of the gantry. Only when the superconducting magnet windings can be kept at the necessary low temperature can the beam guidance and/or deflection magnets of the gantry provide the magnetic field necessary for the beam deflection.

It is one potential object to provide a beam guidance magnet for the deflection of charged particles along a curved path and a cooling device assigned thereto, which are configured so that the superconducting magnet windings of the beam guidance magnet can always be kept at a low temperature necessary for the superconductivity, even when the beam guidance magnet rotates about an axis lying outside itself. It is also a potential object to provide a radiation exposure system having such a beam guidance magnet.

The inventor proposes a beam guidance magnet is to be used for deflecting a beam of electrically charged particles along a curved particle path, the magnet being rotatable about an axis lying outside the magnet and being free from ferromagnetic material which influences the beam guidance. The beam guidance magnet should furthermore contain a system of at least four individual curved superconducting coils extending in the guidance direction of the particle beam, which are arranged pairwise mirror-symmetrically with respect to a beam guidance plane defined by the curved particle path. The beam guidance magnet should furthermore have a cooling device which contains at least one heat sink and at least one solid-state cryobus, the individual superconducting coils being thermally coupled to the at least one heat sink through the solid-state cryobus.

The following advantages are associated with the measures described above by forming the cooling device, assigned to the beam guidance magnet, with the aid of a solid-state cryobus, it is possible to provide a simple cooling device which operates independently of position and has a high reliability. A particular advantage is the obviation of an additional liquid or gaseous refrigerant for direct cooling of the individual superconducting coils.

The beam guidance magnet may additionally have the following features:
A material having a thermal conductivity of more than 100 W/mK at a temperature of 4.2 K may be provided for the at least one solid-state cryobus. By using a material having said property in respect of its thermal conductivity, reliable heat dissipation from the individual superconducting coils to a heat sink can advantageously be ensured.
Copper or a copper alloy may be provided as the material for the at least one solid-state cryobus. Furthermore, aluminum may preferably be provided as the material for the at least one solid-state cryobus. Aluminum, copper or copper alloys have a high thermal conductivity and reliably withstand mechanical loads during operation, as well as when they are being processed. Advantageously, the use of aluminum, copper or a copper alloy for the solid-state cryobus leads to reliable heat dissipation from the individual superconducting coils to a heat sink, together with high reliability and simple processing.
   The system of individual superconducting coils may comprise at least six individual curved superconducting coils extending in the guidance direction of the particle beam, which are arranged pairwise mirror-symmetrically with respect to the beam guidance plane. By using six instead of four individual coils, greater field homogeneity of the magnetic field can be achieved by the two additional correction coils.
The six individual superconducting coils may be configured as follows:
Two saddle-shaped primary coils may have side parts elongated in the beam guidance direction and bent terminating parts at the end. Two at least substantially flat secondary coils of the racetrack type, which are curved in a banana shape, may respectively enclose an inner region in each of which a substantially flat auxiliary coil of the racetrack type, which is curved in a banana shape, may respectively be arranged. By the aforementioned embodiment of the six individual superconducting coils, an optimized arrangement of them can be achieved. Advantageously, this leads to a further improvement in the field homogeneity.
The secondary coils may extend between the bent terminating parts of their respectively associated primary coil. A compact design of the beam guidance magnet can be achieved by said arrangement of the primary and secondary coils.
The conductors of the individual superconducting coils may comprise metallic LTC superconductor material. The operating temperature of individual superconducting coils made of metallic LTC superconductor material may furthermore lie between 4 and 5 K. Low-temperature superconductor material (LTC superconductor material), for example based on niobium-titanium, is technically proven and comparatively simple to process.
   The conductors of the individual coils may instead comprise metal-oxidic HTC superconductor material. For conductors, preferably in strip form, which comprise high-temperature superconductor material (HTC superconductor material), higher operating temperatures can be used compared with LTC superconductor material. These may in particular lie between 10 K and 40 K, preferably between 20 K and 30 K, for the conductors of the individual coils. Compared with the cooling technology for LTC superconductors, the technical outlay is reduced when using HTC superconductors. Furthermore, HTC superconductor material has a sufficiently large critical current-carrying capacity in said temperature range for the generation of strong magnetic fields.
The beam of charged particles which is to be deflected may be a beam of C⁶⁺ particles. When using C⁶⁺ particles, which are particularly effective for medical therapy, the weight and size reduction of a superconductively configured deflection magnet is particularly great. The use of a cooling device which operates position-independently is particularly effective in this case.
The beam guidance magnet may be configured so that a magnetic aperture field strength of at least 2 tesla, preferably between 3 and 5 tesla, is achieved. The use of superconducting magnet windings is particularly advantageous in said range of magnetic field strengths, and the use of a cooling device which operates position-independently is therefore particularly effective.
The heat sinks may be formed by thermal contact surfaces of cold heads. An embodiment of the heat sinks which requires little maintenance and operates position-independently can advantageously be provided by configuring the heat sinks with the aid of cold heads.

The inventor further proposes a radiation exposure system has a stationary radiation source which generates a beam of electrically charged particles. The radiation exposure system furthermore has a plurality of focusing magnets for focusing the particle beam and at least one beam guidance magnet, for deflecting a particle beam. Such a radiation exposure system may, in particular, be characterized in that it has a gantry system that can be rotated about an axis which lies in the beam guidance plane. By the use of beam guidance magnets having superconducting windings, which are equipped with the cooling device, it is possible to provide a radiation exposure system whose beam guidance magnets have a position-independently operating cooling system besides a low design size and a low power requirement.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a longitudinal section through a curved beam guidance magnet having a cooling device,

FIG. 2 shows a cross section through the beam guidance magnet having a cooling device according to FIG. 1,

FIG. 3 shows a detailed view of a cross section of a beam guidance magnet,

FIG. 4 shows a beam guidance magnet in a schematic perspective view, and

FIG. 5 shows a schematic structure of a gantry system using a plurality of curved beam guidance magnets.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

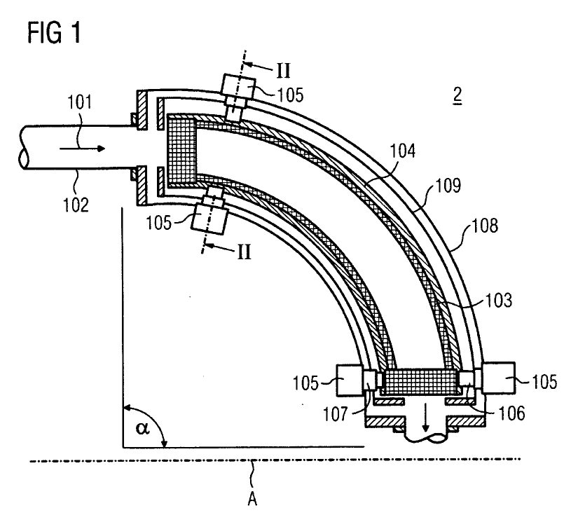

FIG. 1 shows a beam guidance magnet 2 for deflecting a beam of charged particles 101. The beam guidance magnet 2 is mounted so that it can rotate about an axis A, which lies outside the beam guidance magnet 2. As indicated by the dot-and-dash line, the particle beam 101 is deflected through an angle α which preferably lies between 30° and 90°. The particle beam 101 is in particular a beam of electrically charged particles, in particular C⁶⁺ ions. The particle beam 101 is held or guided inside a correspondingly curved beam guidance tube 102 with the aid of magnetic forces. The curved path of the particle beam 101 defines a plane in which the axis A lies, about which the magnet 2 is mounted so that it can rotate.

The magnetic forces guiding the particle beam 101 are generated with the aid of superconducting magnet windings 103. Known materials for such superconducting magnet windings are metallic LTC superconductor material, for example niobium-titanium, or oxidic HTC superconductor material, for example YBaCuO. Operating temperatures of 4.2 K are generally provided for LTC superconductor material. HTC superconductor material can be used at higher operating temperatures of for example 10 to 40 K, preferably from 20 to 30 K. At said temperatures, HTC superconductor materials have sufficiently high critical current densities in order to generate the required magnetic field strengths.

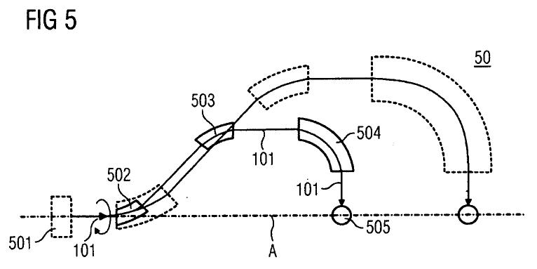

According to a preferred exemplary embodiment, the beam guidance magnet 2 may be equipped with four or more superconducting magnet windings 103. More details of this exemplary embodiment will be explained in connection with FIG. 4.

In order to keep the superconducting magnet windings 103 at a low temperature required for the superconductivity, it is necessary to equip the beam guidance magnet 2 with a corresponding cooling device. According to a preferred exemplary embodiment, the superconducting magnet windings 103 are cooled by at least one solid-state cryobus 104.

A solid-state cryobus in this context is intended to mean a solid body which connects at least one heat source and at least one heat sink to one another, preferably mechanically but at least thermally, without using liquid or gaseous media. The purpose of a solid-state cryobus is to convey a dissipated heat flux from a heat source to be cooled to a heat sink which provides refrigerating power. The term solid-state cryobus in this context is not restricted to the use of particular materials. A solid-state cryobus may preferably be made from materials with good thermal conductivity, for example copper. A solid-state cryobus is intended to mean both the connection between a heat source and a heat sink and the connection of a plurality of heat sources to a heat sink, or conversely the connection of a heat source to a plurality of heat sinks. A solid-state cryobus may be a component manufactured in one piece, or a component composed of a plurality of individual parts. A solid-state cryobus may furthermore be made from an essentially bulk and/or mechanically rigid material, for example a copper block. Without restriction of the term solid-state cryobus, it may likewise be formed of a flexible material which is preferably not configured solidly, for example a bundle of copper filaments or strands.

In relation to the preferred exemplary embodiment of a beam guidance magnet 2 as represented in FIG. 1, the solid-state cryobus 104 establishes the thermal contact between the superconducting winding 103 (or plurality of superconducting windings 103) and at least one cold head 105. The solid-state cryobus 104 is on the one hand in good thermal contact with the superconducting winding 103 of the beam guidance magnet 2, and on the other hand likewise in good thermal contact with a second stage 106 of one or more cold heads 105.

The solid-state cryobus 104 may furthermore be electrically separated from the superconducting magnet winding 103 by insulation with a comparatively good thermal conductivity (not represented in FIG. 1).

The thermal conductivity of the solid-state cryobus 104 may preferably be better than 100 W/mK at a temperature of 4.2 K. Copper or a copper alloy is preferably to be used as the material for the solid-state cryobus 104. For thermal insulation of the superconducting windings 103, the second stage 107 of one or more cold heads 105 may be connected to a cryoshield 109. A further improvement in the thermal insulation of the superconducting magnet windings 103 may be achieved by using so-called superinsulation, although for the sake of clarity this is not represented in FIG. 1.

The superconducting magnet windings 103, the solid-state cryobus 104 and the radiation shield 109 are contained in a common cryostat 108, which may simultaneously form the housing of the beam guidance magnet 2. The housing, or the cryostat 108, of the beam guidance magnet 2 may be evacuated for further thermal insulation.

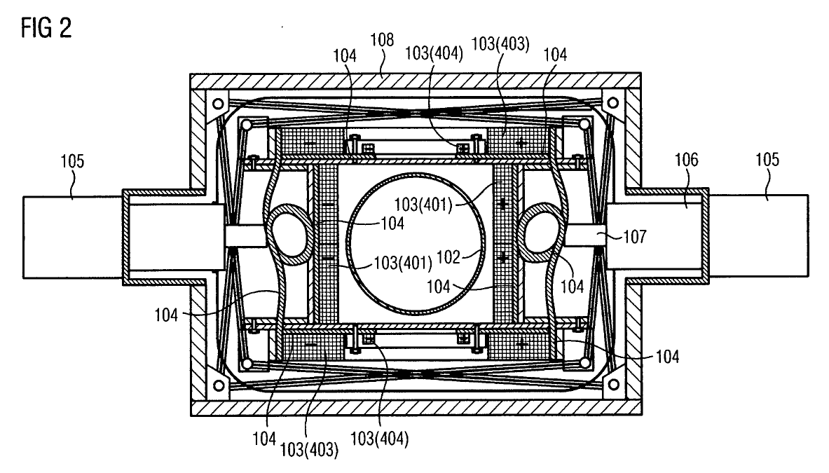

The more detailed configuration of the beam guidance magnet 2, in particular the arrangement of the superconducting magnet windings 103, is revealed by the schematic cross-sectional drawing represented in FIG. 2. According to a preferred exemplary embodiment, the cross section shown in FIG. 2 may correspond to the section (II-II) through the beam guidance magnet 2 as indicated in FIG. 1.

As may be seen from FIG. 2, a plurality of superconducting magnet windings 103 are arranged around a beam guidance tube 102, in which the particle beam 101 is guided. The schematically represented superconducting magnet windings 103 are also provided with mathematical signs, which indicate the current flow direction. According to a preferred exemplary embodiment, six superconducting magnet windings 103 may be used to generate a beam-deflecting magnetic field. More details about the configuration of these six superconducting magnet windings 103 will be explained in connection with FIG. 4.

In order to cool them, the superconducting magnet windings 103 are connected through a cryobus 104 to the second stage 106 of a two-stage cold head 105. The first stage of this cold head is denoted by 107. As seen in cross section, the cryobus 104 preferably does not form an electrically closed current path fully enclosing the beam tube 102. This is because by avoiding an electrically closed current path fully enclosing the beam tube 102, it is possible to prevent a ring current from being induced in the solid-state cryobus 104 when there is a change in the excitation currents of the superconducting magnet windings 103. Such an induced ring current would possibly have a perturbing effect on the magnetic fields which are generated by the superconducting magnet windings 103, and which are used for the beam guidance.

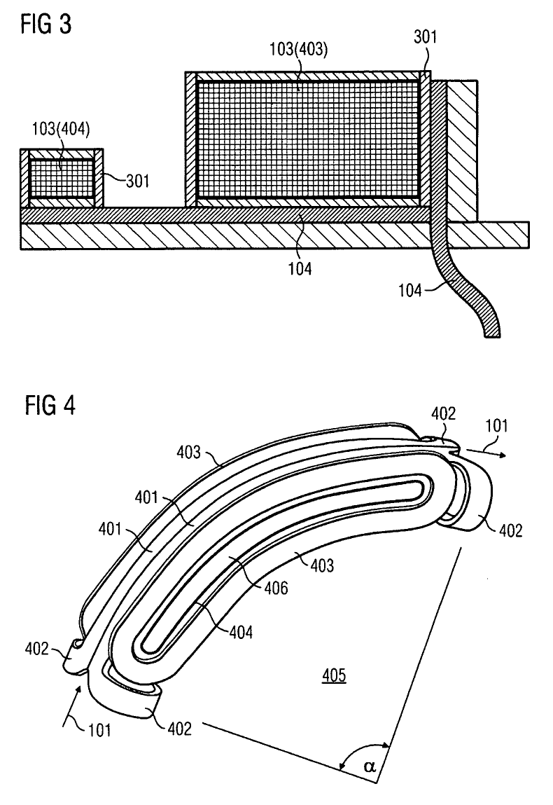

In order to improve the thermal coupling of the superconducting magnet windings 103 to the solid-state cryobus 104, it is possible to use additional thermal conduction plates 301 which enclose the superconducting magnet windings 103. FIG. 3 shows a detailed view of the cross section of the beam guidance magnet 2 as represented in FIG. 2. By an arrangement of special thermal conduction plates 301 as is shown in FIG. 3, the refrigerating power introduced into the individual superconducting windings 103 by the branched cryobus 104 can be distributed more homogeneously.

FIG. 4 shows the system of six superconducting magnet windings which has already been mentioned in connection with FIG. 2. According to a preferred exemplary embodiment, a beam of charged particles 101 can be deflected through an angle α by an arrangement of six individual coils as is shown in FIG. 4. The deflection angle α may preferably be between 30° and 90°. The curved path of the charged particles 101 defines a plane 405. The system of six individual superconducting coils is designed pairwise mirror-symmetrically with respect to this plane 405. The system of six individual superconducting coils comprises two coils designed with a saddle shape and elongated in the beam guidance direction, which are referred to as primary coils 401. Each of these primary coils 401 has two curved side parts extending laterally with respect to the beam guidance tube, and two terminating parts 402 at the end. The terminating parts 402 at the ends are respectively bent or offset from the surface spanned by the side parts of the primary coil, so that they respectively extend in the shape of a semicircular arc around the beam guidance tube. The side parts of the primary coils 401 do not actually need to extend exactly in a curved surface (segment of a lateral cylinder surface) and also the terminating parts 402 at the ends do not need to be designed exactly in the shape of a semicircular arc.

Two substantially flat secondary coils 403, which are curved in a banana shape, are arranged lying in two mutually parallel planes on sides respectively neighboring the flat sides of the primary coils at 90°. These coils are configured as curved racetrack coils, and they preferably extend between the terminating parts 402 at the ends of the primary coils 401. The secondary coils 403 respectively enclose an inner region 406 curved in a banana shape. Further so-called auxiliary coils 404, which are likewise curved in a banana shape, are arranged in this inner region. More details about the system of six individual superconducting coils may be found in the DE application 10 2006 018 635.4, which was not yet published at the priority date of the present application.

The system of six individual superconducting coils as represented in FIG. 4 may, according to a preferred exemplary embodiment, be equipped with a solid-state cryobus 104 (not represented in FIG. 4) for cooling the superconducting coils 401 to 404. The configuration of the solid-state cryobus is revealed by FIGS. 2 and 3, in which the cross sections corresponding to the primary coils 401, secondary coils 403 and auxiliary coils 404 are respectively provided with the corresponding references. One or more beam guidance magnets according to one of the exemplary embodiments above are to be used in a radiation exposure system. Such a radiation exposure system preferably has a gantry, which is represented schematically in FIG. 5. Such a rotatably mounted gantry 50 has a radiation source 501 (not described in detail) for generating a beam of charged particles, for example C⁶⁺ ions. These ions emerge from the source 501 in a direction which establishes the position of an axis, about which the gantry 50 is rotatably mounted. The gantry rotation axis is denoted by A in FIG. 5. In such a gantry 50, for example with the aid of two 45° deflection magnets 502 and 503, the particle beam 101 emerging along the axis A from the radiation source 501 can be deflected into a region away from the axis. From there, the particle beam 101 can be deflected by a 90° deflection magnet 504, which corresponds to the beam guidance magnet 2 according to FIGS. 1 to 4, in a direction perpendicular to the rotation axis A. There, at the so-called ISO-center 505, the particle beam 101 preferably strikes tissue to be irradiated, for example a subject's tumor. Other combinations of deflection magnets are of course also suitable for a gantry, for example one 45° magnet and one 135° magnet, or two 30° magnets and one 120° magnet.

For comparison purposes, dashed lines in FIG. 5 indicate a magnet system which would be obtained if corresponding normally conducting magnets with field-shaping iron yokes were to be used instead of a system of superconducting magnets. Comparing a magnet system with normally conducting magnets which have field-shaping iron yokes, and a magnet system having superconducting magnets, for the known magnet the ISO-center 505 would lie about 6 m further away from the ion source 501 than is the case with a system having superconducting magnets.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-15. (canceled)

16. A beam guidance magnet device for deflecting a beam of electrically charged particles along a curved particle path, comprising:
a rotation unit to rotate the magnet device about an axis lying outside the magnet device;
a system of at least four individual curved superconducting coils extending along the curved path to deflect the particle beam, the curved superconducting coils being arranged pairwise mirror-symmetrically with respect to a beam guidance plane defined by the curved particle path; and
a cooling device comprising at least one heat sink and at least one solid-state cryobus, the individual superconducting coils being thermally coupled to the at least one heat sink through the at least one solid-state cryobus, wherein
the magnet device is substantially free from a ferromagnetic material that would influence the beam guidance.

17. The beam guidance magnet device as claimed in claim 16, wherein,
the at least one solid-state cryobus is formed of a material having a thermal conductivity of more than 100 W/mK at a temperature of 4.2 K.

18. The beam guidance magnet device as claimed in claim 17, wherein
the at least one solid-state cryobus is formed of aluminum, copper or a copper alloy.

19. The beam guidance magnet device as claimed in claim 16, wherein,
the system of individual superconducting coils comprises at least six individual curved superconducting coils extending along the curved path to deflect the particle beam, the curved superconducting coils being arranged pairwise mirror-symmetrically with respect to the beam guidance plane.

20. The beam guidance magnet device as claimed in claim 19, wherein, the coil system of the at least six individual superconducting coils comprises:
two saddle-shaped primary coils each having a side part elongated along the curved path and bent terminating parts at end of the side part,
two at least substantially flat secondary coils of a racetrack type, which are curved in a banana shape, each secondary coil enclosing an inner region within the race track, and
two at least substantially flat auxiliary coils of the racetrack type, which are curved in a banana shape and are respectively arranged in the inner regions of respective secondary coils.

21. The beam guidance magnet device as claimed in claim 20, wherein,
the secondary coils each extend between the bent terminating parts of a respectively associated primary coil.

22. The beam guidance magnet device as claimed in claim 16, wherein,
the conductors of the individual superconducting coils are formed from a metallic Low Temperature Conducting (LTC) superconductor material.

23. The beam guidance magnet device as claimed in claim 16, wherein,
the conductors of the individual coils are formed from a metal-oxidic High Temperature Conducting (HTC) superconductor material.

24. The beam guidance magnet device as claimed in claim 22, wherein the superconducting coils have a superconductive operating temperature of between 4 and 5 K.

25. The beam guidance magnet device as claimed in claim 23, wherein the superconducting coils have a superconductive operating temperature of between 10 K and 40 K.

26. The beam guidance magnet device as claimed in claim 23, wherein the superconducting coils have a superconductive operating temperature of between 20 K and 30 K.

27. The beam guidance magnet device as claimed in claim 16, wherein the beam of electrically charged particles is a beam of C⁶⁺ particles.

28. The beam guidance magnet device as claimed in claim 16, wherein the superconducting coils generate a magnetic aperture field strength of at least 2 tesla.

29. The beam guidance magnet device as claimed in claim 16, wherein the superconducting coils generate a magnetic aperture field strength of between 3 and 5 tesla.

30. The beam guidance magnet device as claimed in claim 16, wherein,
each heat sink has a thermal contact surface of a cold head.

31. A radiation exposure system, comprising:
a stationary radiation source which generates a beam of electrically charged particles;
a plurality of focusing magnets for focusing the beam of electrically charged particles; and
a beam guidance magnet device for deflecting the beam of electrically charged particles along a curved particle path, comprising:
a rotation unit to rotate the magnet device about an axis lying outside the magnet device;
a system of at least four individual curved superconducting coils extending along the curved path to deflect the particle beam, the curved superconducting coils being arranged pairwise mirror-symmetrically with respect to a beam guidance plane defined by the curved particle path; and
a cooling device comprising at least one heat sink and at least one solid-state cryobus, the individual superconducting coils being thermally coupled to the at least one heat sink through the at least one solid-state cryobus, wherein
the magnet device is substantially free from a ferromagnetic material that would influence the beam guidance.

32. The radiation exposure system as claimed in claim 31, further comprising a gantry system having a plurality of beam guidance magnet devices that rotate about the rotation axis, which lies in the beam guidance plane.
